(19) United States
(12) Patent Application Publication
(10) Pub. No.: US 2008/0040473 A1
(43) Pub. Date: Feb. 14, 2008

(54) ENABLING WEB ANALYTICS FOR INTERACTIVE WEB APPLICATIONS

(75) Inventors: JEFFREY E. LARSSON, Kirkland, WA (US); Jigar Mody, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/464,283

(22) Filed: Aug. 14, 2006

(51) Int. Cl. G06F 15/173

(52) U.S. Cl. 709/224

(57) ABSTRACT

A method is provided for tracking user-interaction with an interactive web application associated with a web page. The method includes providing one or more modified HTML elements for use with the web page. The default behavior of the HTML elements is modified to include a call to a tracking server. The interactive web application associated with the web page includes at least one of the modified HTML elements. User interaction information is then sent to the tracking server according to the call in the modified HTML elements.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

The development of the internet or World Wide Web has included the development of different techniques for presenting information, such as web pages, to a user. Asynchronous JavaScript and XML (“AJAX”) is one web development technique for creating interactive web applications. The intent behind an AJAX enabled web page is to make the web page feel more responsive by exchanging only small amounts of data with a server so that the entire web page does not have to be reloaded each time a user makes a change. This is meant to increase the web page's interactivity, speed and usability. However, the fact that AJAX allows web pages to be updated without the requirement to request a full page of HTML each time a change is made, poses special problems to the field of web analytics. Web analytics, broadly speaking, is the measurement of a user's behavior as they visit and interact with a website and/or web page.

Currently, there are two widely used technological approaches to collecting web analytics data, logfile analysis and page tagging. Logfile analysis records every transaction made between a client and a web server. Logfile analysis thus results in large data files. These large data files often result in performance issues and a lag in obtaining meaningful information. Further, while the initial call of a transaction can be tracked with web server logfile analysis, a problem arises when the call to the web service returns a rich set of data. AJAX makes it possible to download a rich set of data (e.g. XML data) from the web server and store it in a browser's memory. This in turn makes it possible for a user to interact with a web page (e.g. by clicking on a link) without any transaction taking place between the client and server. Therefore, logfile analysis is unable to track these transactions that take place only on the client and without a call to the web server. So using logfile records when AJAX pages are used presents an incomplete picture of the user's interaction with the website.

The other approach to collecting analytic data is JavaScript page tagging. Page tagging uses a page view as a basic tracking event. One advantage of page tagging is the typically resultant smaller data set, as compared to logfile analysis. Also, by using JavaScript, page tagging utilizes a small invisible image to pass along with the image request certain information about the page and the visitor. This information can then be processed by a web analytics company or other processing entity. This allows for another advantage in page tagging, in that the data is typically sent to a tracking server for timely processing. This allows reports to be generated from data that is only minutes old. In contrast, logfile analysis is typically done by post-processing logs from the previous day. So the web analytics can be outsourced to a third party. Page tagging has also been extended from mere page view tracking, to tracking a selection of a hyperlink. One way to accomplish this is by placing JavaScript in each hyperlink. However, web sites are typically composed of countless hyperlinks, so to instrument each one of the links individually is not practical. Therefore, developers take advantage of the fact that web pages are static by executing JavaScript which attaches to each hyperlink currently existing on a page. This works because the page is static. Once a page is rendered, there is a static set of HTML and a static set of hyperlinks; therefore, it is possible to enumerate each hyperlink and modify the anchor tag (“a-tag”) to have tracking code. However, with an AJAX enabled web page, this approach does not work. Because the AJAX enabled page is not static there is no way to enumerate each hyperlink that may eventually appear on the page. So the page tagging approach with AJAX enabled pages will also present an incomplete picture of the user's interaction with the website. Therefore, traditional processes for collecting web analytic data are unable to accurately collect information about visitors on an AJAX enabled web page.

An approach called redirection is yet another common approach for tracking. Using redirection, one or more name/value pairs are appended to the URL. The name/value pairs are query string parameters that direct the user to a tracking page. The tracking page reads the query string parameters and then redirects the user to the final destination, which is typically a different website. As an example, the user might click on a link to a merchant website. Before arriving at the merchant website, the user would first be redirected through an intermediate tracking page. The tracking page then writes to a database, text file or other data store. Redirection thus requires that each link be modified to include this tracking infrastructure. Moreover, due to its very nature, redirection does not allow tracking for simple page views, such as a page refresh.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In one embodiment, a method is provided for tracking user-interaction with an interactive web application associated with a web page. The method includes providing one or more modified HTML elements for use with the web page. The default behavior of the HTML elements is modified to include a call to a tracking server. The modification generally involves modifying the default behavior of existing tags to add additional events to the behavior of the tag. The additional events include a call to a tracking server. The interactive web application associated with the web page includes at least one of the modified HTML elements. Because the behavior of the tags has been modified, user interaction information is then sent to the tracking server according to the call in the modified HTML elements.

In another embodiment, a method is provided for tracking user-interaction with one or more dynamically rendered HTML elements on an interactive web application associated with a web page. The method includes receiving information about an event from a modified HTML element. The event is from within the interactive web application. The information is received from the HTML element because the default behavior of the HTML element has been modified to include a call to a tracking server that receives the information.

In yet another embodiment, a method is provided that allows tracking user-interaction with an interactive web application associated with a web page. The method includes determining a set of HTML elements that are desired to be tracked. The default behavior of these elements is then modified to include a call to a tracking server. The call included in the default behavior allows tracking of each element within the interactive web application.

### BRIEF DESCRIPTION OF THE SEVERAL VIEWS OF THE DRAWINGS

The present invention is described in detail below with reference to the attached drawing figures, which are incorporated by reference herein and wherein:

FIG. 1 is a block diagram of an exemplary computing environment suitable for use in implementing embodiments of the present invention;

FIG. 2 is a block diagram of an exemplary computing device suitable for use in implementing embodiments of the present invention;

FIG. 3 is a flow diagram illustrating a method for tracking user-interaction with an interactive web application associated with a web page in accordance with an embodiment of the present invention;

FIG. 4 is a flow diagram illustrating a method for allowing tracking of user-interaction on an interactive web application associated with a web page in accordance with an embodiment of the present invention;

FIG. 5 is a flow diagram illustrating a method for tracking user-interaction with one or more dynamically rendered HTML elements on an interactive web application associated with a web page in accordance with an embodiment of the present invention; and

FIG. 6 is a block diagram of an exemplary architecture for use in implementing embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed, unless and except when the order of individual steps is explicitly described.

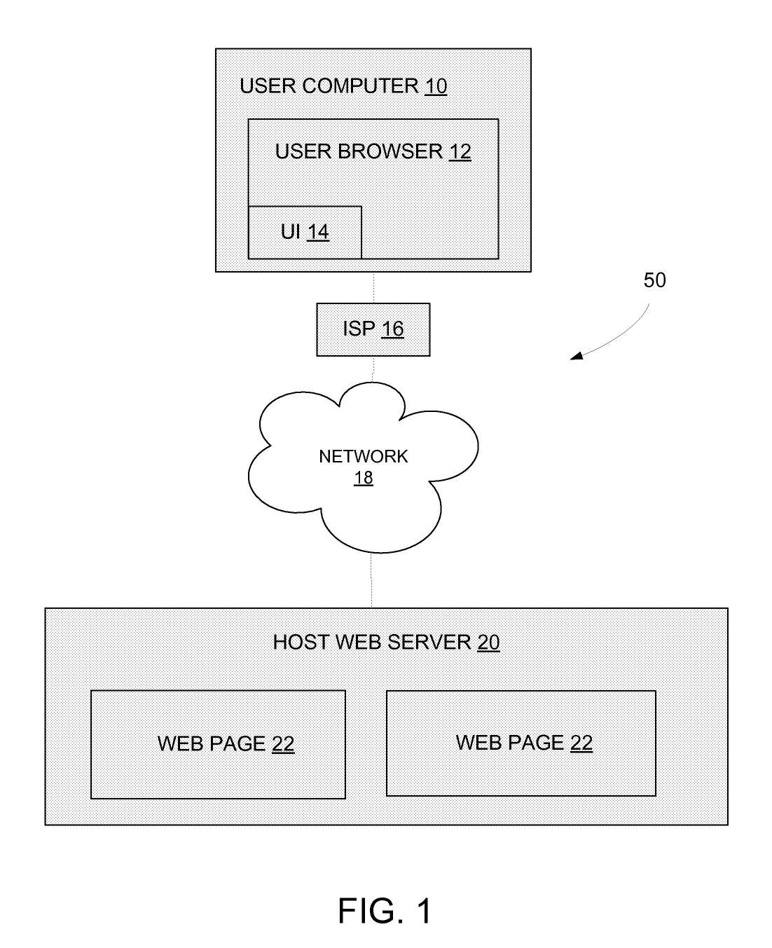

FIG. 1 illustrates a system 50 that represents an exemplary environment in which the present invention may be practiced. The system 50 including a computing device 10 having a user browser 12 accessible through a user interface (UI) 14. The computing device 10 may be connected over a network 18 through an Internet Service Provider (ISP) 16. The network 18 includes routers, root servers and virtual name servers, as is known to those of skill in the art. The ISP 16 and the network 18 allow the computing device 10 to interact with a host server 20 through the browser 12. Host 20 can operate to deliver or serve desired web pages 22 to the computing device 10. Other components that are not shown may also be included, but would be known to those of skill in the art.

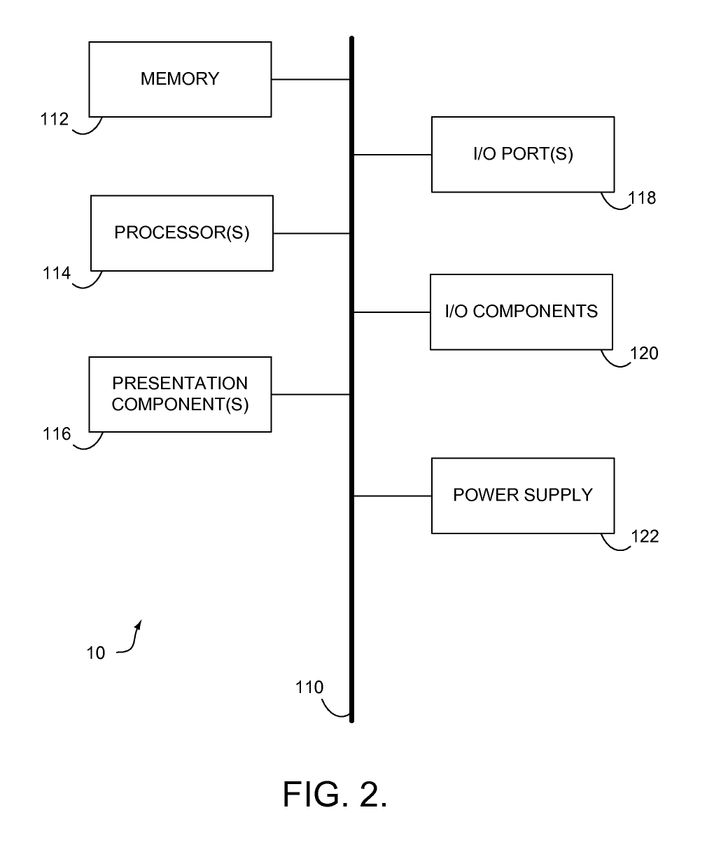

Referring to FIG. 2, a basic configuration of computing device 10 is shown. Computing device 10 is but one example of a suitable computing environment and is not intended to suggest any limitation as to the scope of use or functionality of the invention. Neither should the computing device 10 be interpreted as having any dependency or requirement relating to any one or combination of components illustrated.

While computing device 10 is shown, other system configurations, including hand-held devices, consumer electronics, general-purpose computers, more specialty computing devices, etc may also be used. With continued reference to FIG. 2, computing-device 10 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 2 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 2 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 2 and reference to “computing device.”

Computing device 10 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 10.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 10 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 10 to be logically coupled to other devices including I/O components 120, some of which may be built in. Illustrative components include a microphone, joystick, game pad, satellite dish, scanner, printer, wireless device, etc.

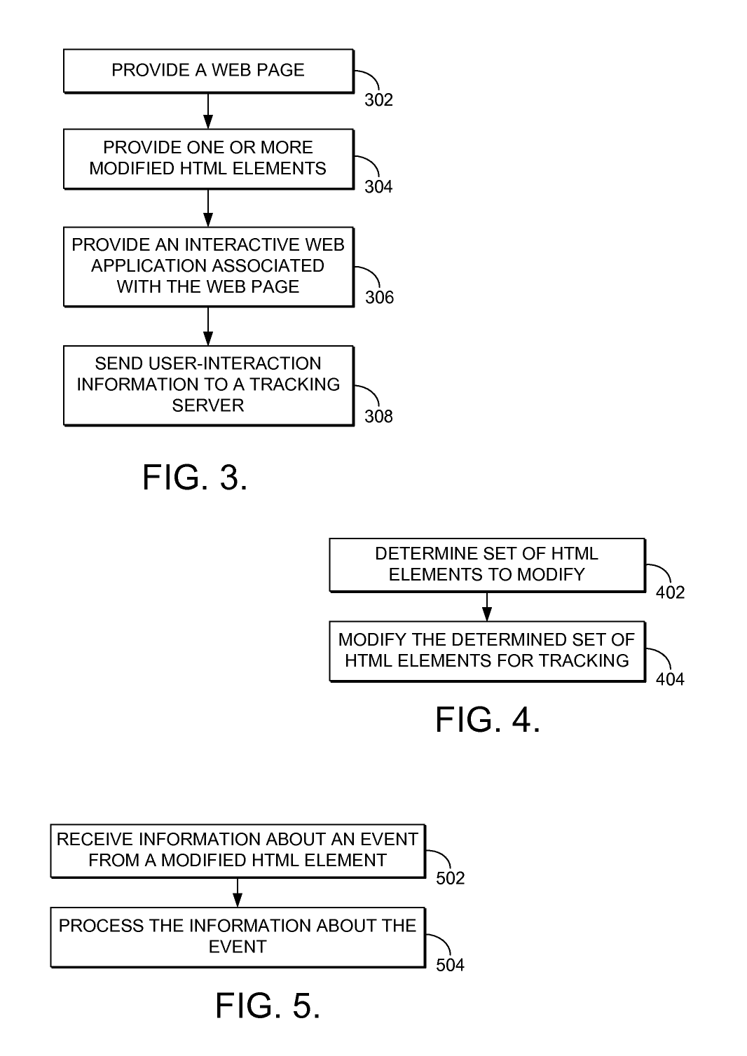

Referring now to FIG. 3, a flow diagram is illustrated that shows an exemplary method for tracking user-interaction with an interactive web application associated with a web page. Initially, as indicated by block 302, a web page (such as web page 22) is provided upon a request from the user browser 12 to the host 20 of FIG. 1. As shown at block 304, one or more modified HTML elements are provided for use with the web page, as will be described in further detail below. The provided web page may include dynamic HTML through the use of AJAX. The modified HTML elements allow web analytic tracking of the user interaction with the web page even when an AJAX enabled web page is served from the host 20. At block 306, an interactive web application associated with the provided web page may be provided to the computing device 10 by host 20. The interactive web application may also have a dynamic, AJAX enabled portion. The interactive web application also includes modified HTML elements that contain a call to the tracking server, as described in further detail below.

Subsequently, as indicated in block 308, user-interaction information is sent to a tracking server according to a call in the modified HTML elements. The modification of the HTML element includes a modification of the default behavior of the element. The default behavior is modified to instruct that user-interaction information be sent in certain situations. The modification of the default behavior of the HTML elements is further described below. In one embodiment, the tracking server may be a third party server that processes data and stores the data in a database. In another embodiment, the tracking server is an internal server. By way of example only, and not by limitation, the data processed and stored by the tracking server may include information about a person requesting the web page (e.g., name, address, weight, height, gender, age, race, education, occupation, etc.), where the request for the web page originated from (e.g., search engine, hyperlink on a web page, typed URL, etc.), and how long the web page was viewed.

Turning now to the modification of the default behavior of the HTML elements, reference is made to FIG. 4. As shown at block 402, a determination of which HTML elements to modify is made. In one embodiment, an administrative user makes the determination as to which HTML elements to modify to allow for tracking. The administrative user may choose to modify every tag of a specific type on a web page. For example, the default behavior of all of the a-tags could be modified. The a-tag is an HTML element that denotes an anchor—a hypertext link or the destination of a link within a web page. The a-tag is one of the possible HTML elements that could be modified. A user's interaction with an a-tag would likely be interesting in the context of web analytics, and so it is used here as an example. It should be understood that the invention is in no way limited to a-tags, or any other type of tag. In yet another embodiment, the administrative user may choose to modify only certain tags in certain areas of a web page. Therefore, the default behavior of div-tags are modified such that when a div-tag is used, the style reflects that tracking is desired for the div-tag.

Once a determination is made as to which set of HTML elements are to be modified, at block 404, the default behavior of the determined set of HTML elements is modified to include a call to a tracking server. By way of example only and not limitation, two modified HTML elements are provided below:

```
a- tag
      <style> INPUT {behavior:url(ClickTrack.htc)}
      A {behavior:url(ClickTrack.htc)}
      </style>
div-tag
      <div id=“ClickDiv” style=
      “BEHAVIOR:url(ClickTrack.htc)”>Click Div</div>
```

The underlying code for the clicktrack.htc includes a call to allow tracking. Again, by way of example only and not limitation, an example of the clicktrack.htc code is:

```
<PUBLIC:COMPONENT URN=“urn:msdn-microsoft-com:workshop” >
    <PUBLIC:ATTACH EVENT=“onclick”
    ONEVENT=“clickTrack( )” />
    <SCRIPT LANGUAGE=“JScript”>
    function clickTrack( )
    {
        if(xReq)
        {
        xReq.open(“POST”, “/WebApp2/DummyPage.htm”, true);
        sequencer++;
        xReq.send(window.event.srcElement.id.toString( )+
        “\t”+sequencer);
        }
    window.event.cancelBubble = true;
    }
    </SCRIPT>
</PUBLIC:COMPONENT>
```

Using a tag with the modified default behavior will thus result in a call to the tracking server when, for example, a user interacts with an a-tag on the web page. This call will occur without having to enumerate each element on the page, and will occur as the elements are loaded on the page. This allows true web analytic tracking of pages using AJAX. Thus, even though the page has dynamic content, a user's interaction with the page can be determined.

To obtain the benefit of the modified HTML elements, the web developer will use the modified elements in web design. It is beneficial to allow typical web developers to incorporate these modified elements in an easy, unobtrusive way. One method for incorporating the elements is to place the modified HTML elements in the common include file. A server-side include (SSI) file is a tool used in web page creation. The include file allows one master file to be used that can benefit many pages. Then to modify one boilerplate element, only the include file need be modified instead of updating every individual page. By modifying the default behavior of the determined set of HTML elements, web designers can obtain the benefit of web analytic tracking without having to individually modify each HTML element during web page creation. Instead the web page developer need only specify the include file that contains the modified HTML elements.

One with ordinary skill in the art will appreciate that modifying the default behavior of a-tags to included a call to a tracking server will not only modify the a-tags that currently exist on the web page, but any a-tag appearing on the web page thereafter. Further, the code to modify a-tags only needs to be written one time by a developer and placed in the include file. Therefore, any other developer working on features to the web site need only to adopt the common code in the include file to incorporate these changes (i.e.; the modification of the default behavior of a-tags) into a page. Therefore, only one person (the initial developer) needs to know what tags to modify and how to modify the default behavior of these certain tags.

Referring now to FIG. 5, a description of the actions at a tracking server are described. At block 502, information about an event from a modified HTML element is received. In one embodiment, the modified HTML element is modified to send information about the event to the tracking server. By way of example only, and not by limitation, information about an event may include a description of the event (e.g., description of the event, date, time of day, location on the web page the event took place, etc.) along with information about the user executing the event (e.g., address, weight, height, gender, age, race, education, occupation, etc.). An event that initiates a call to the tracking server may be, for example, a selection of a hyperlink or a mouse pointer hovering over a hyperlink.

Subsequently, at block 504, information about an event is processed by the tracking server. By way of example only, and not by limitation, processing the information may include, but is not limited to, organizing the information received, storing the information and presenting the information to a user. The presentation of the information may be through an electronic report displayed on a monitor, a printed report, or presented to the user through any other acceptable format. Various ways of presenting information are known to one with ordinary skill in the art and, accordingly, are not further discussed herein.

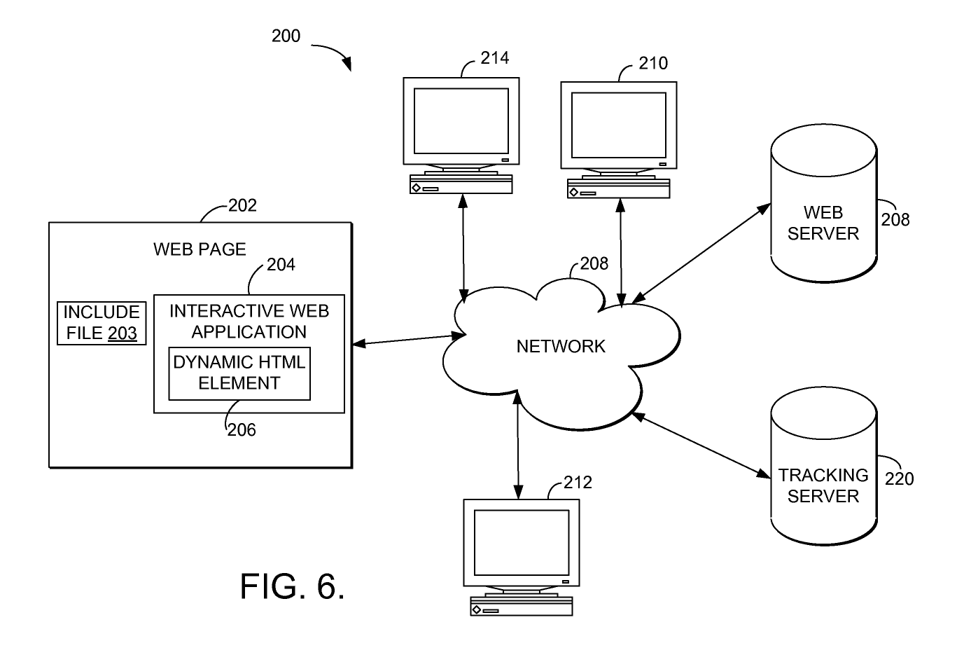

Referring now to FIG. 6, a block diagram is illustrated that shows an overall exemplary block architecture diagram 200 that is meant to supplement the discussion of FIGS. 1-5 above. It will be understood and appreciated by those of ordinary skill in the art that the overall architecture 200 shown in FIG. 2 is merely an example of one suitable computing environment and is not intended to suggest any limitation as to the scope of use or functionality of the present invention. Neither should the overall architecture 200 be interpreted as having any dependency or requirement related to any single component or combination of components illustrated therein.

Architecture 200 includes an administrative computing device 210, a web page development device 212 and a user computing device 214. Device 214 operates as described above with respect to FIG. 1 and user computer 10. The devices 210 and 212 operate similarly, but are used for different purposes in the exemplary embodiment. Each of the devices 210-214 is connected to a network 208. Each of the user devices 210-214 may be any type of computing device, such as, for example, a computing device 10 described above with reference to FIGS. 1 and 2.

Administrative computing device 210 is used in the creation of the modified HTML elements. Device 210 is used to alter the default behavior of the HTML elements selected according to the description above with reference to FIG. 4. Once modified, the HTML elements are provided for use by web page developers through the network 208. As described above, this can be done through the include file. The web page development computing device 212 is used to create a web page 202. The created web page will include a reference to the include file 203, and will thus have HTML elements that adopt the modified behavior described above. Once created, the web page is made available though a web host 208, which is similar to the host 20 described with reference to FIG. 1. The user computing device 214 utilizes a browser, as described with reference to FIG. 1, to navigate to and request a particular web page 202. As shown, the web page 202 may have an interactive web application 204 and a dynamic HTML element 206. Using AJAX, for example, the element 206 can change without reloading the entire page. This makes traditional page tracking inaccurate with respect to those elements. However, using HTML elements with a modified default behavior allows accurate tracking for web analytic purposes. As the user interacts with the web page 202, and specifically with the modified HTML elements, a call is made to a tracking server 220. Because the default behavior of the HTML element is modified, all elements created on the page will adopt the modified behavior and allow the user interaction to be tracked. This occurs both for statically loaded elements as well as dynamically loaded elements. As the elements are loaded, they have the modified default behavior. So, web page 202 is configured with HTML elements having modified default behavior to send information about user interaction to tracking server 212. Tracking server 220 may be a third party server that processes data and stores the data in a database or tracking server 220 may be an internal server.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method for tracking user-interaction with an interactive web application (204) associated with a web page (202), comprising:
providing one or more modified HTML elements (304) for use with the web page, wherein said one or more modified HTML elements include a call to a tracking server;
providing an interactive web application associated with the web page (306), wherein said interactive web application comprises at least one of said one or more modified HTML elements; and
sending user-interaction information to said tracking server (308) according to said call in said one or more modified HTML elements.

2. The method of claim 1, wherein the interactive web application is an AJAX-enabled application.

3. The method of claim 1, wherein said one or more modified HTML elements are modified such that the default behavior of the HTML elements includes a call to the tracking server.

4. The method of claim 3, wherein said modified HTML element comprises an a-tag or a div-tag.

5. One or more computer-readable media having computer-useable instructions embodied thereon for performing the method of claim 1.

6. A method for allowing tracking of user-interaction on an interactive web application (204) associated with a web page (202), comprising:
determining a set of HTML elements (402) desired to be tracked; and
modifying said determined set of HTML elements to include a call to a tracking server (404), wherein said call allows tracking of user interaction with each element within said interactive web application.

7. The method of claim 6, wherein the web page is an AJAX enabled web page.

8. The method of claim 7, wherein said modification is a modification of the default behavior of said determined set of HTML elements.

9. The method of claim 8, wherein each HTML element of said set is a tag.

10. The method of claim 9, wherein said tag further comprises an a-tag or a div-tag.

11. The method of claim 7, further comprising presenting information about said tracked event to a user.

12. One or more computer-readable media having computer-useable instructions embodied thereon for performing the method of claim 6.

13. A method for tracking user-interaction with one or more dynamically rendered HTML elements (206) on an interactive web application (204) associated with a web page (202), comprising:
receiving information about an event from a modified HTML element (502), wherein said event is within said interactive web application;
wherein said modified HTML element is modified to generate said information; and
processing said information about said event (504).

14. The method of claim 13, wherein said web page is an AJAX enabled web page.

15. The method of claim 14, wherein said modification is a modification of said HTML element's default behavior.

16. The method of claim 15, wherein said modified HTML element is a tag.

17. The method of claim 16, wherein said tag further comprises an a-tag or a div-tag.

18. The method of claim 13, wherein said event further comprises selecting a link or hovering a mouse pointer over said link.

19. One or more computer-readable media having computer useable instructions embodied thereon for performing the method of claim 13.
